(19) United States
(12) Patent Application Publication
(10) Pub. No.: US 2005/0015929 A1
(43) Pub. Date: Jan. 27, 2005

(54) Braking system for braking a first element relative to a second element, and a vehicle seat including such a braking system

(76) Inventors: Christophe Aufrere, Marcoussis (FR); Slawomir Klukowski, Paris (FR); Alain Laporte, Guyancourt (FR)

Correspondence Address: MCCRACKEN & FRANK LLP, 200 W. ADAMS STREET, SUITE 2150, CHICAGO, IL, 60606, US

(21) Appl. No.: 10/894,988

(22) Filed: Jul. 20, 2004

(30) Foreign Application Priority Data
Jul. 25, 2003 (FR) 03 09142

(51) Int. Cl. E05D 11/08

(52) U.S. Cl. 16/337

(57) ABSTRACT

A braking system for braking a first element (2) pivotally mounted on a pivot pin (6) that is secured to a stationary second element (3). The system includes a helical spring (18) which has a diameter adapted so that, in the assembled state, said helical spring (18) is in contact against the inside wall (15) of a sleeve (14) secured to the second element, the helical spring (18) being adapted so as to make it possible, while the first element is pivoting, to increase the diameter of the helical spring (18) so as to increase the friction force between the helical spring (18) and the sleeve (14), thereby causing the pivoting of the first element (2) to be braked.

### FIELD OF THE INVENTION

The present invention relates to a braking system for braking the movement of a first element relative to a second element, and to a vehicle seat including such a braking system.

More particularly, the invention relates to a braking system for braking a first element pivotally mounted on a pivot pin that is secured to a stationary second element, while the first element is pivoting from a first position towards a second position in a first pivot direction.

### BACKGROUND OF THE INVENTION

In this type of braking system for braking a first element relative to a stationary second element, the braking means are generally formed by pneumatic or hydraulic actuators that make it possible to brake the pivoting of the first element in the first pivot direction relative to the stationary second element. Unfortunately, use of pneumatic and/or hydraulic actuators increases quite considerably the cost of manufacturing such braking systems, and such actuators are also relatively voluminous, which makes it difficult to install them in known braking systems. In addition, such pneumatic and/or hydraulic actuators are of limited use or are even impossible to use when the angular pivot stroke of the first element relative to the second element, during braking, is greater than or equal to 900.

### OBJECTS AND SUMMARY OF THE INVENTION

An object of the invention is, in particular, to mitigate those drawbacks.

To this end, according to the invention a braking system for braking a first element relative to a second element comprises:
a drive member pivotally mounted on the pivot pin and that is designed to be driven in the first pivot direction by the first element;
a spring member which connects the drive member to the pivot pin, said spring member urging the drive member in a second pivot direction opposite to the first pivot direction;
a sleeve mounted in stationary manner on the pivot pin and that has a cylindrical inside wall which co-operates with the drive member to form a housing; and
a helical spring which has a diameter adapted so that, in the assembled state, said helical spring is in contact against the inside wall of the sleeve, said helical spring having one end secured to the drive member so as to make it possible firstly, while the drive member is pivoting in the first pivot direction, to increase the diameter of the helical spring so as to increase the friction force between the helical spring and the sleeve, thereby causing the pivoting of the first element relative to the second element to be braked, and secondly, while the drive member is pivoting in the second pivot direction under drive from the spring member, to reduce the diameter of the helical spring so as to reduce substantially the friction force between the helical spring and the sleeve.

In preferred embodiments of the invention, it is optionally possible to use one or more of the following provisions:
the drive member is adapted to be pivoted by the first element only while said first element is pivoting within a predetermined angular range and in the first pivot direction;
the drive member is adapted to be pivoted by the first element only when said first element enters the predetermined angular range;
the first element is provided with a projecting member designed to come into abutting contact against a drive abutment on the drive member so as to enable said drive member to pivot while the first element is pivoting over the predetermined angular range;
the first element is further connected to the second element by means an angular adjustment system adapted to make it possible firstly for the angular position of the first element to be adjusted over a first angular range including the first position, the adjustment system being adapted to lock or unlock the pivoting of the first element about the pivot pin over said first angular range, and secondly for the first element to pivot over a second angular range including the second position;
the drive member is adapted to be pivoted by the first element only while said first element is pivoting over the second angular range and in the first pivot direction;
the drive member is adapted so that, while the drive member is pivoting in the second pivot direction, said drive member comes into abutting contact against the sleeve mounted in stationary manner on the pivot pin so that said drive member always comes into a predetermined relative position relative to the stationary second element;
the drive member is provided with a stud which is designed to come into abutting contact against the sleeve when said drive member reaches its predetermined relative position relative to the second element;
the spring member is formed by a spiral spring; and
the first and second elements are formed respectively by a seat back and by a seat proper of a vehicle seat.

In addition, the invention also provides a motor vehicle seat comprising a seat back pivotally mounted on a seat proper, the seat back and the seat proper being connected together via a second spring member designed to urge the seat back to pivot in the first pivot direction, said motor vehicle seat being characterized in that the seat back and the seat proper are further connected together via a braking system as defined above.

### BRIEF DESCRIPTION OF THE DRAWINGS

Other characteristics and advantages of the invention appear from the following description of one of the embodiments thereof, given by way of non-limiting example and with reference to the accompanying drawings.

In the drawings:

FIG. 1 is a side view of a motor vehicle seat in the normal in-use position, and as equipped with a system of the invention for assisting braking;

FIGS. 2 and 3 are views similar to the FIG. 1 view, with the seat back respectively in an intermediate position and in a folded-down position in which it forms a tabletop;

FIG. 4 is a fragmentary side view of the braking assistance system that connects the seat proper to the back of the vehicle seat;

FIG. 5 is a perspective view showing the braking assistance system which interconnects the seat back and the seat proper of the vehicle seat;

FIG. 6 is a section view of the braking assistance system of the invention; and

FIG. 7 is a perspective and fragmentary perspective view of the braking assistance system of the invention.

### MORE DETAILED DESCRIPTION

In the various figures, like references designate elements that are identical or similar.

FIG. 1 shows a vehicle seat 1 provided with a fold-down tabletop function.

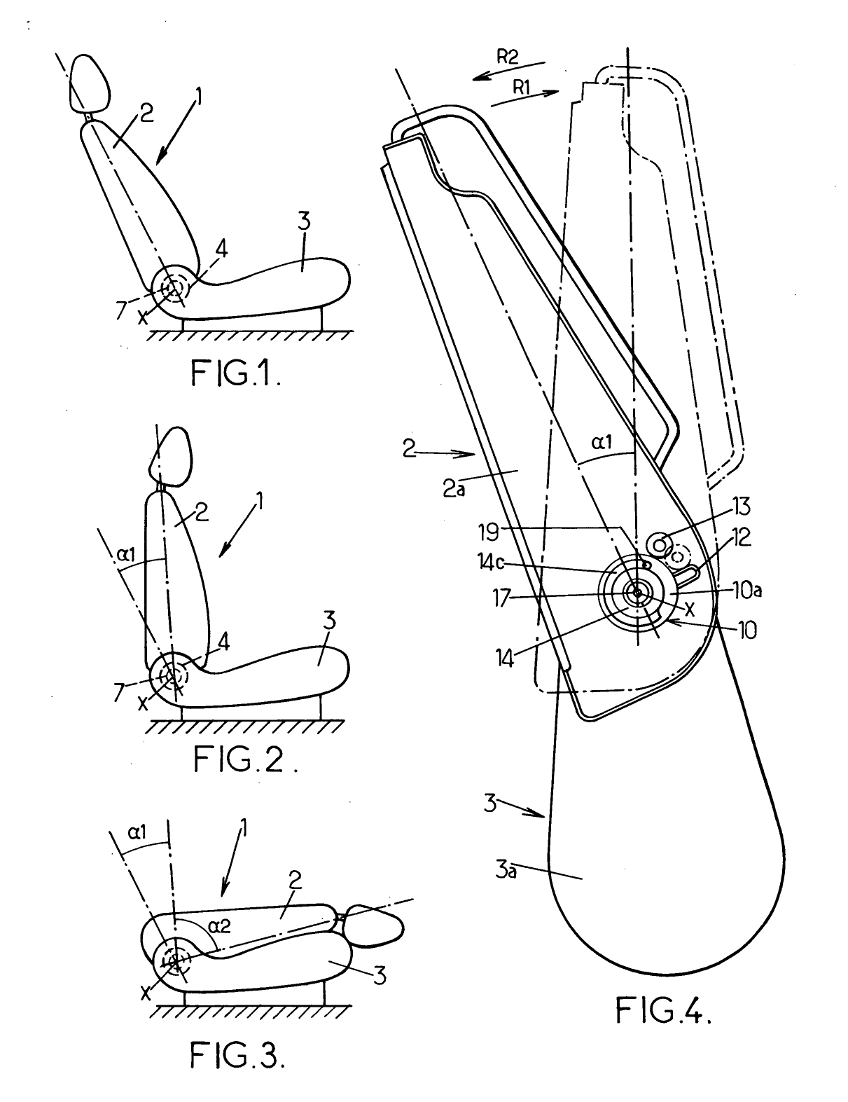

The seat 1 includes a seat back 2 which is mounted to pivot on a seat proper 3 about a pivot axis X that is substantially horizontal and transverse, so as to adjust the inclination of the seat back 2, in particular in comfort positions (FIGS. 1 and 2) or in the folded-down position in which it forms a tabletop (FIG. 3). The comfort positions of said seat back 2 can be angularly adjusted by a user by means of a hinge 4 that is known per se, and that is controlled by a control system, e.g. a rotary knob connected directly to the hinge 4. The hinge 4 can be disposed either on one or on both of the side edges of the seat proper 3 that connect to the seat back 2.

In a comfort position, the seat back 2 can, for example, be angularly adjusted over a first angular range α1 as shown in FIG. 2. The first angular range α1 for adjusting the seat back 2 is defined between a rear upstanding position (FIG. 1) and a front upstanding position (FIG. 2) of the seat back 2.

For example, the angular adjustment system formed by the hinge 4 can comprise a first cheek plate (not shown) mounted on the seat proper 3 or on the structure of the seat proper, and a second cheek plate mounted on the seat back 2, and a hinge mechanism adapted to enable either the second cheek plate to turn relative to the first cheek plate about the pivot axis X, or the second cheek plate to be locked angularly relative to the first cheek plate.

Within the first angular range α1 through which the seat back 2 can turn about the pivot axis X, the hinge 4 is adapted to enable the pivoting of the second cheek plate on the seat back 2 relative to the first cheek plate on the seat proper 3 to be either locked or unlocked.

The seat proper 3 is carried by a base which can, for example, be formed by two mutually parallel runners which connect the seat proper 3 directly to the floor of the vehicle.

As can be seen in FIG. 3, the seat back 2 can also be tilted forwards over a second angular range α2 from any one of the comfort positions lying in the first angular range α1. The hinge 4 is adapted to bring the seat back to a folded-down position in which it forms a tabletop, as shown in FIG. 3. In this folded-down tabletop-forming position, the seat back 2 extends parallel to the seat proper 3, the rear face 21 of the seat back 2 preferably being sufficiently rigid to serve as an abutment surface and thereby to constitute a tabletop.

Thus, when a user whishes to bring the back 2 into a folded-down tabletop-forming position (FIG. 3), the user firstly unlocks the hinge 4 by means of any appropriate system and then causes the back 2 of the seat to pivot in a first pivot direction R1, i.e. forwards in this example, and about the pivot axis X. In which case, the back 2 pivots through the second angular range α2 situated beyond the first angular range α1 corresponding to the comfort position of said back 2 being adjusted.

The hinge can be adapted so that, while the back 2 is pivoting through the second angular range α2, said hinge does not lock the pivoting of said back 2 relative to the seat proper 3 even when the hinge mechanism tends to return to its locking position. Examples of such a hinge are given, for example, in Document FR-A-2 673 519.

As can be seen in FIG. 6, the seat 1 is also provided with a spring member 5 which serves to urge the back 2 to pivot in the first pivot direction R1 when the user of the seat adjusts the position of the back 2 within the first angular range α1. The spring member 5 can, for example, be in the form of a spiral spring having a first end 5a serving to co-operate with a pivot pin 6 secured to the rigid structure 3a of the seat proper 3 and a second end (not shown) serving to co-operate with the rigid structure 2a of the seat back 2. The pivot pin 6 mounted in stationary manner on the rigid structure 3a of the seat proper 3 extends along the pivot axis X. The spiral spring 5 also serves to pivot the seat back 2 in the first pivot direction R1 and within second angular range α2 while the seat back 2 is being folded down fully towards its tabletop position, as shown in FIG. 3.

In addition, as can be seen in FIG. 6, the rigid structure 2a of the back 2 is also provided with an opening 2b which surrounds the pivot pin 6 secured to the rigid structure 3a of the seat proper 3, and said rigid structure 2a of the seat back 2 is secured to a washer 8 which is also provided with an opening whose periphery 8a is mounted to pivot about the pivot pin 6. To this end, the periphery 8a of the washer 8 can, for example be provided with a coating having a low coefficient of friction, such as a coating of polytetrafluoroethylene. The washer 8 comes into contact with a shoulder 6a provided on the pivot pin 6, and the washer 8 is prevented from being moved along the pivot pin 6 by means of a second washer 9 mounted directly in stationary manner on the pivot pin 6.

The seat 1 is also provided with a brake system 7 serving to brake the pivoting of the back 2 when said back is within the second angular range α2, said system braking the back against the force exerted by the spiral spring 5.

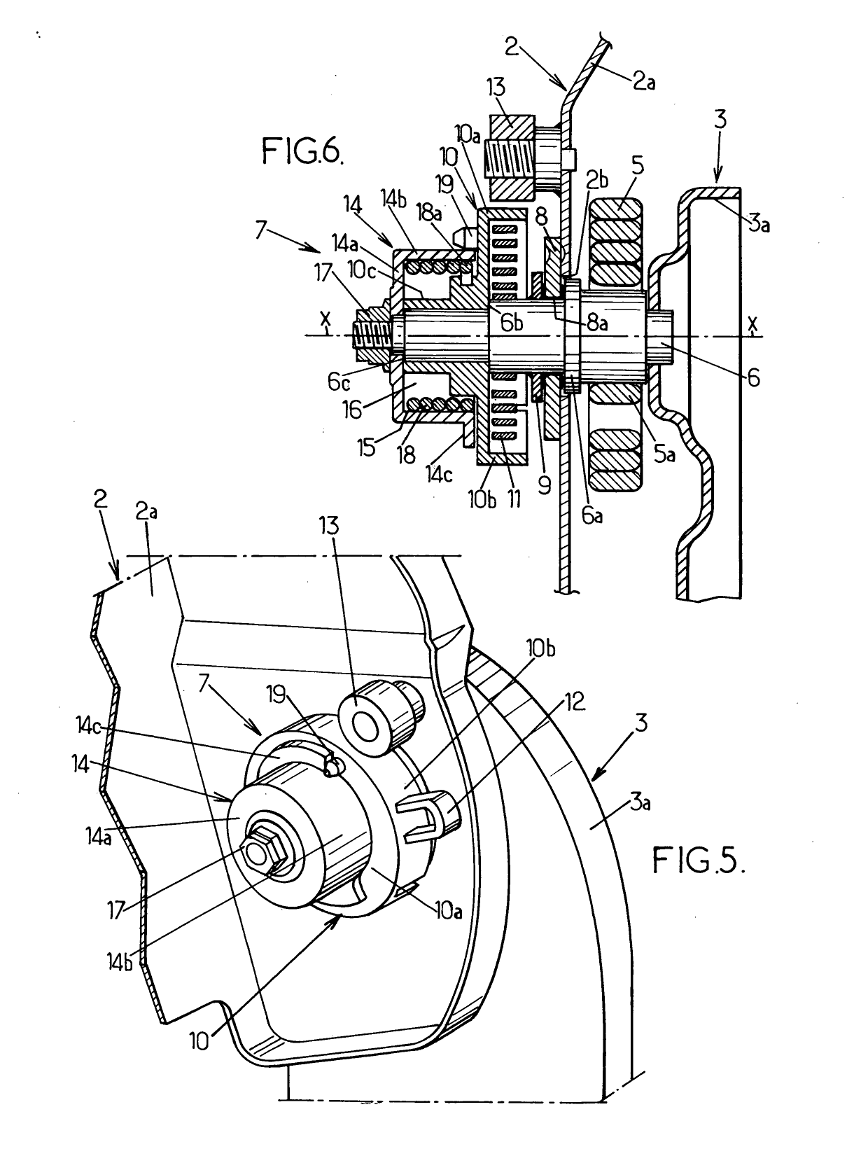

The braking system 7 is described in detail below with reference to FIGS. 4 to 7.

The braking system 7 comprises a drive member 10 which is pivotally mounted directly on the pivot pin 6, and which serves to be driven in the first pivot direction R1 by the rigid structure 2a of the back 2. The drive member 10 has a first portion in the form of a dish-shaped washer 10a that extends perpendicularly to the pivot pin 6 and that is extended by a rim 10b parallel to the pivot axis 6 and extending towards the rigid structure 2a of the seat back 2. In addition, the drive member 10 also has a cylindrical portion 10c that extends away from the rigid structure 2a of the seat back 2, which cylindrical portion 10c has an inside wall mounted to move in rotation on the pivot pin 6. The cylindrical portion 10c of the drive member 10 also bears against a second shoulder 6b provided on the pivot pin 6. The drive member 10 is also connected to the pivot pin 6 by means of a spring member 11 which has a first end secured to the pivot pin 6 and a second end secured to the projecting rim 10b of the drive member 10 so as to urge said drive member 10 in a second pivot direction R2 opposite from the first pivot direction R1. For example, the spring member 11 can be formed by a spiral spring.

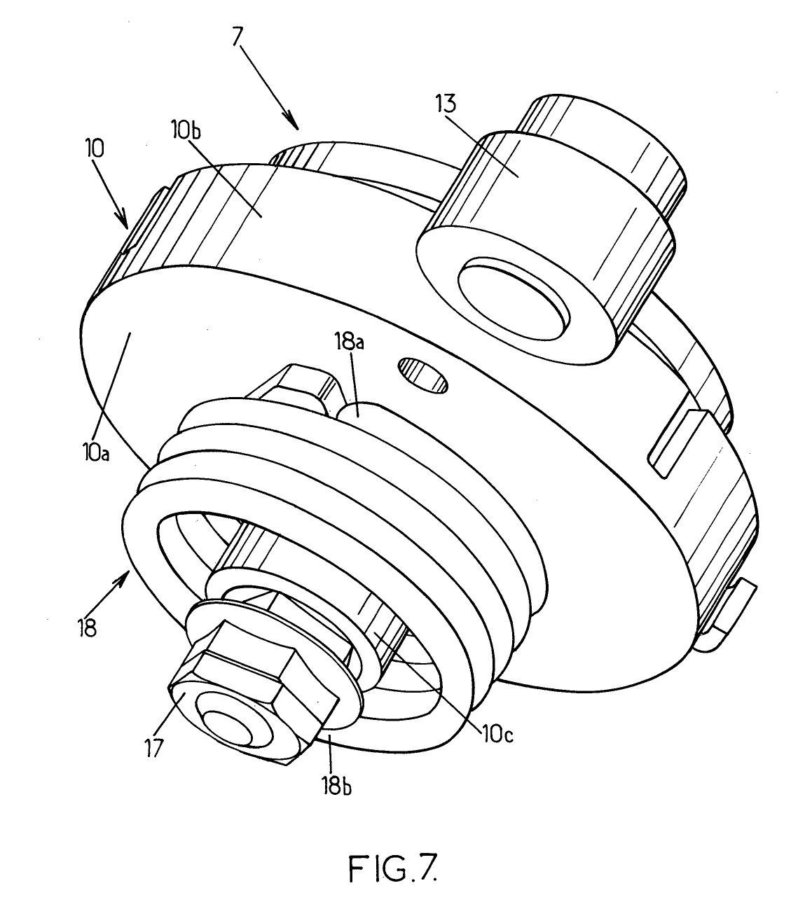

In addition, as can be seen in FIGS. 4 and 5, the drive member 10 is also provided with a drive abutment 12 disposed on the projecting rim 10b and that serves to co-operate with a projecting member 13 mounted directly in stationary manner on the rigid structure 2a of the back 2. More exactly, the projecting member 13 on the rigid structure 2a serves to come into abutting contact against the drive abutment 12 of the drive member 10 when the back 2 is on the borderline between the first and second angular ranges α1, α2. This position is shown in dashed lines in FIG. 4.

Thus, when the back 2 enters the second angular range α2, the projecting member 132 on the rigid structure 2a of the back 2 causes the drive member 10 to pivot via the drive abutment 12 thereon, against the force exerted by the spiral spring 11 disposed inside the dish-shaped washer 10a of said drive member 10.

In addition, the braking system 7 further comprises a sleeve 14 that is substantially bell-shaped and that has a wall 14a perpendicular to the pivot pin 6 and a cylindrical wall 14b which is parallel to the pivot pin 6 and which extends towards the drive member 10. The cylindrical wall 14b of the sleeve 14 has a cylindrical inside wall 15 which co-operates with the cylindrical portion 10c of the drive member 10 to form a housing 16. The sleeve 14 is mounted directly on the pivot pin 6 secured to the rigid structure 3a of the seat proper 3, and is stationary to said pivot pin 6, e.g. by means of a nut 17 which makes it possible for the wall 14a of the sleeve 14 to be brought into abutment and stationary against a third shoulder 6c provided on the pivot pin 6. The sleeve 14 is indexed angularly on the pivot pin 6 when it is stationary thereto, and the pivot pin 6 is itself indexed angularly on the rigid structure 3a of the seat proper 3.

In addition, the braking system 7 further comprises a helical spring 18 which has a diameter adapted so that, when said helical spring 18 is mounted inside the housing 16, said helical spring is in contact with the inside wall 15 of the sleeve 14. As can be seen in more detail in FIG. 7, which shows the braking system 7 without its sleeve 14, the helical spring 18 has a first end 18a that is stationary directly to the cylindrical portion 10c of the drive member 10, and a second end 18b that is mounted freely inside the housing 16 formed by the sleeve 14 and by the drive member 10. The helical spring 18 is designed to be mounted so that it is in contact with the inside surface 15 of the sleeve 14 when said sleeve is mounted on the pivot pin 6.

The winding direction of the helical spring 18 from its first end 18a towards its second end 18b corresponds to the first pivot direction R1 in which the seat back pivots.

Thus, when a user wishes to bring the seat back 2 into its tabletop position as shown in FIG. 3, the user firstly unlocks the hinge 4 while the seat back 2 is in a comfort position lying within the first angular range α1, and then the user allows the seat back 2 to pivot in the first pivot direction R1 towards the second angular range α2 under drive from the spiral spring 5 disposed between the rigid structure 3a of the seat proper 3 and the rigid structure 2a of the seat back 2.

Under drive from said spring 5, the seat back 2 enters the second angular range α2 as shown in FIG. 4. In this configuration, the projecting member 13 on the rigid structure 2a of the seat back 2 drives the drive abutment 12 in rotation and thus causes the drive member 10 to pivot in the first pivot direction R1. The drive member 10 then tends to drive the end 18a of the helical spring 18 in the first pivot direction R1. Whereupon, the helical spring, under the effect of its turns being in contact against the inside wall 15 of the sleeve 14, then tends to increase its diameter, thereby increasing the friction force between the set of its turns and the inside wall 15 of the sleeve 14, thereby causing the pivoting of the seat back 2 relative to the seat proper 3 to be braked until the back 2 reaches its tabletop position.

It should also be noted that, while the seat back 2 is pivoting in the first pivot direction R1, the spiral spring 11 also tends to brake the pivoting of the seat back 2 slightly, even though the main function of said spiral spring 11 does not lie in braking the seat back 2 over the second angular range α2.

Conversely, when the user wishes to bring the seat back 2 into an in-use upstanding position, the user causes the seat back 2 to pivot against the drive exerted by the spiral spring 5 so that the projecting member 13 pivots in the second pivot direction R2, thereby enabling the spiral spring 11 to cause the drive member 10 to pivot in the second pivot direction R2. The drive member 10 pivoting in the second pivot direction R2 also causes the first end 18a of the helical spring 19 to pivot, thereby enabling the diameter of said helical spring 18 to be reduced. This reduction in the diameter of the helical spring makes it possible to reduce substantially the friction force between the turns of the helical spring 18 and the inside wall 15 of the sleeve 14, thereby allowing the seat back 2 to pivot towards an in-use upstanding position.

As can be seen in FIG. 5, the drive member 10 is also provided with a stud 19 which serves to come into abutting contact, while said drive member is pivoting in the pivot direction R2, against a radially projecting flange 14c on the sleeve 14.

Since the sleeve 14 is stationary with angular indexing on the pivot pin 6 which is itself secured to the rigid structure 3a of the seat proper 3, the stud 19 thus makes it possible for the drive member 10 always to be returned to a predetermined relative position relative to the seat proper 3, under drive from the spiral spring 11. Said predetermined angular position of the drive member 10 corresponds to a position in which the projecting member 13 on the rigid structure 2a of the seat back is designed to be in abutting contact with the drive abutment 12 of said drive member 10, when the seat back 2 enters the second angular range α2.

In the above description, the drive member 10 is caused to pivot when the seat back 2 enters the second angular range α2 so as to brake the pivoting of the seat back 2 by increasing the friction force between the helical spring 18 and the sleeve 14. However, it is also possible to arrange the projecting member 13 and the drive abutment 12 on the drive member 10 differently so that the seat back 2 drives the drive member 10 so that it pivots into a different position, e.g. lying within the angular range α2.

Similarly, the hinge 4 can be adapted to bring the seat back into an intermediate folded-down position so as, for example, to give access to the rear seats of a vehicle having only two side doors, the braking system 7 then being adapted to brake the pivoting of the seat back as soon as said seat back enters the second angular range α2.

1. A braking system for braking a first element pivotally mounted on a pivot pin that is secured to a stationary second element, while the first element is pivoting from a first position towards a second position in a first pivot direction;
said system comprising:
a drive member pivotally mounted on the pivot pin and that is designed to be driven in the first pivot direction by the first element;
a spring member which connects the drive member to the pivot pin, said spring member urging the drive member in a second pivot direction opposite to the first pivot direction;
a sleeve mounted in stationary manner on the pivot pin and that has a cylindrical inside wall which co-operates with the drive member to form a housing; and
a helical spring which has a diameter adapted so that, in the assembled state, said helical spring is in contact against the inside wall of the sleeve, said helical spring having one end secured to the drive member so as to make it possible firstly, while the drive member is pivoting in the first pivot direction, to increase the diameter of the helical spring so as to increase the friction force between the helical spring and the sleeve, thereby causing the pivoting of the first element relative to the second element to be braked, and secondly, while the drive member is pivoting in the second pivot direction under drive from the spring member, to reduce the diameter of the helical spring so as to reduce substantially the friction force between the helical spring and the sleeve.

2. A system according to claim 1, wherein the drive member is adapted to be pivoted by the first element only while said first element is pivoting within a predetermined angular range and in the first pivot direction.

3. A system according to claim 2, wherein the drive member is adapted to be pivoted by the first element only when said first element enters the predetermined angular range.

4. A system according to claim 2, wherein the first element is provided with a projecting member designed to come into abutting contact against a drive abutment on the drive member so as to enable said drive member to pivot while the first element is pivoting over the predetermined angular range.

5. A system according to claim 1, wherein:
the first element is further connected to the second element by means an angular adjustment system adapted to make it possible firstly for the angular position of the first element to be adjusted over a first angular range including the first position, the adjustment system being adapted to lock or unlock the pivoting of the first element about the pivot pin over said first angular range, and secondly for the first element to pivot over a second angular range including the second position; and
the drive member is adapted to be pivoted by the first element only while said first element is pivoting over the second angular range and in the first pivot direction.

6. A system according to claim 1, in which said drive member is adapted so that, while the drive member is pivoting in the second pivot direction, said drive member comes into abutting contact against the sleeve mounted in stationary manner on the pivot pin so that said drive member always comes into a predetermined relative position relative to the stationary second element.

7. A system according to claim 6, wherein the drive member is provided with a stud which is designed to come into abutting contact against the sleeve when said drive member reaches its predetermined relative position relative to the second element.

8. A system according to claim 1, in which the spring member is formed by a spiral spring.

9. A system according to claim 1, in which the first and second elements are formed respectively by a seat back and by a seat proper of a vehicle seat.

10. A motor vehicle seat comprising a seat back pivotally mounted on a seat proper, the seat back and the seat proper being connected together via a second spring member designed to urge the seat back to pivot in the first pivot direction, the seat back and the seat proper are further connected together via a braking system according to claim 9.
